(19) United States
(12) Patent Application Publication
(10) Pub. No.: US 2008/0056263 A1
(43) Pub. Date: Mar. 6, 2008

(54) EFFICIENT TRANSPORT LAYER PROCESSING OF INCOMING PACKETS

(76) Inventors: Vinit Jain, Austin, TX (US); Alexander Medvedev, Austin, TX (US); Ketan P. Pancholi, Austin, TX (US); Venkat Venkatsubra, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/470,455

(22) Filed: Sep. 6, 2006

(51) Int. Cl. H04L 12/56

(52) U.S. Cl. 370/392; 370/401

(57) ABSTRACT

A method for improving the efficiency of Internet Protocol Control Block (INPCB) lookup operations at a TCP receiver and TCP sender. The TCP/IP stack is modified such that every data packet generated includes both data and INPCB address information. Specifically, the TCP/IP stacks of a sending device and a receiving device are modified to provide a contemporaneous transmission of INPCB addresses along with each data packet. The TCP/IP stack of the receiver is also modified such that the receiver echoes this INPCB address along with each TCP packet sent back to the sender to eliminate the necessity of an INPCB address lookup operation at the sending device. Contemporaneous transmission of data and INPCB addresses facilitates direct delivery of data packets to the corresponding sockets.

### BACKGROUND OF TILE INVENTION

1. Technical Field

The present invention relates in general to the field of computers and other data processing systems and in particular to computer networking. Still more particularly, the present invention relates to an improved method and system for handling Transmission Control Protocol (TCP) and Internet Protocol Control Block (INPCB) information.

2. Description of the Related Art

Packet switching is a communications paradigm utilized to facilitate communication across a computer network. Data is divided into packets that may be individually routed between the nodes of a network, thereby optimizing the bandwidth available, increasing the robustness of the network, and also minimizing the transmission latency. The transmission latency is defined as the time it takes for data to pass across the network. A set of communications protocols, known as the internet protocol suite, implement the packet switching processes by which most computer networks, such as the internet, operate. The Internet protocol suite may be viewed as a set of layers, including different levels of upper, middle, and lower layers. Upper layers are typically closer to the user, deal with more abstract data, and rely on lower layer protocols to translate data into forms suitable for physical transmission. The internet protocol suite is sometimes referred to as the TCP/IP protocol suite, named after the two most important protocols in the suite: Transmission Control Protocol (TCP), which is an intermediate transport layer protocol; and Internet Protocol (IP), which is a lower network layer protocol.

Every TCP connection requires the creation of a corresponding lower layer Internet Protocol Control Block (INPCB) that saves information, such as local port, foreign port, local address, foreign address, corresponding socket, and the like. Applications send streams of octets (8-bit bytes) to a TCP/IP stack for delivery through a network, and the TCP/IP stack divides the byte stream into appropriately sized segments. The TCP/IP stack then passes the resulting packets to the lower layer IP, for delivery through a network to the TCP/IP stack of the destination entity. During transmission, the TCP/IP stack checks to make sure that no packets are lost by giving each packet a sequence number, which is also used to make sure that the data packets are delivered to the entity at the other end in the correct order. Furthermore, the TCP/IP stack at the far end sends back an acknowledgement for packets that have been successfully received.

When the TCP/IP stack receives a packet, it needs to deliver the packet to a corresponding socket. To determine which socket the packet belongs to, the TCP/IP stack performs a lookup from a table of INPCBs and compares the local port, foreign port, local address, and foreign address information in the packet with that in each INPCB to find a unique match. However, as the number of TCP connections increases, this INPCB lookup becomes increasingly inefficient. For example, on a busy server, the number of INPCBs typically runs into thousands. The corresponding lookup of INPCBs consumes a lot of processing time and is often the single most time consuming operation in the TCP/IP stack. Contemporary TCP/IP implementations store INPCBs in a hash table data structure in an effort to increase the efficiency of the lookup process. However, this hash table based implementation may become problematic as the size of the hash chain increases. The present invention thus recognizes than a method and system are needed for substantially eliminating the inefficiency with the aforementioned INPCB lookup operations and thereby increasing the TCP/IP performance of computer networks.

### SUMMARY OF THE INVENTION

Disclosed is a method, system, and computer program product for substantially improving the efficiency of Internet Protocol Control Block (INPCB) lookup operations at a packet receiving terminal or device of a Transmission Control Protocol (TCP) based computer network transmission. The TCP/Internet Protocol (IP) stack is modified such that every data packet generated includes both data and INPCB address information. This modification of the TCP/IP stack substantially eliminates INPCB address lookup times and thus decreases TCP/IP processing times, thereby optimizing the transmission latency of a computer network. Specifically, the TCP/IP stacks of a sending device and a receiving device are modified to provide a contemporaneous transmission of INPCB addresses along with each data packet. The TCP/IP stack of the receiver is also modified such that the receiver echoes this INPCB address along with each TCP packet sent back to the sender to eliminate the necessity of an INPCB address lookup operation at the sending device. Contemporaneous transmission of data and INPCB addresses facilitates direct delivery of data packets to the corresponding sockets. Accordingly, the need for inefficient, time-intensive INPCB lookup operations following a TCP transmission is substantially reduced, and the modification of the TCP/IP stack to enable concurrent transmission of the INPCB enables quick, efficient, and scalable TCP communication.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary data processing system connected to a computer network, in accordance with an embodiment of the present invention;

FIG. 2 illustrates a Transmission Control Protocol (TCP) connection, with modifications provided according to one embodiment of the present invention;

FIG. 3 is a high level logical flowchart of an exemplary method of TCP transmission from the perspective of a TCP sender in accordance with one embodiment of the invention; and

FIG. 4 is a high level logical flowchart of an exemplary method of TCP transmission from the perspective of a TCP receiver in accordance with one embodiment of the invention.

### DETAILED DESCRIPTION OF AN ILLUSTRATIVE EMBODIMENT

The present invention provides a method, system, and computer program product for substantially improving the efficiency of Internet Protocol Control Block (INPCB) lookup operations at sender or receiver device of a Transmission Control Protocol (TCP) based computer network transmission by modifying the TCP/Internet Protocol (IP) stacks of the TCP sender and TCP receiver such that every data packet includes both data and INPCB address information.

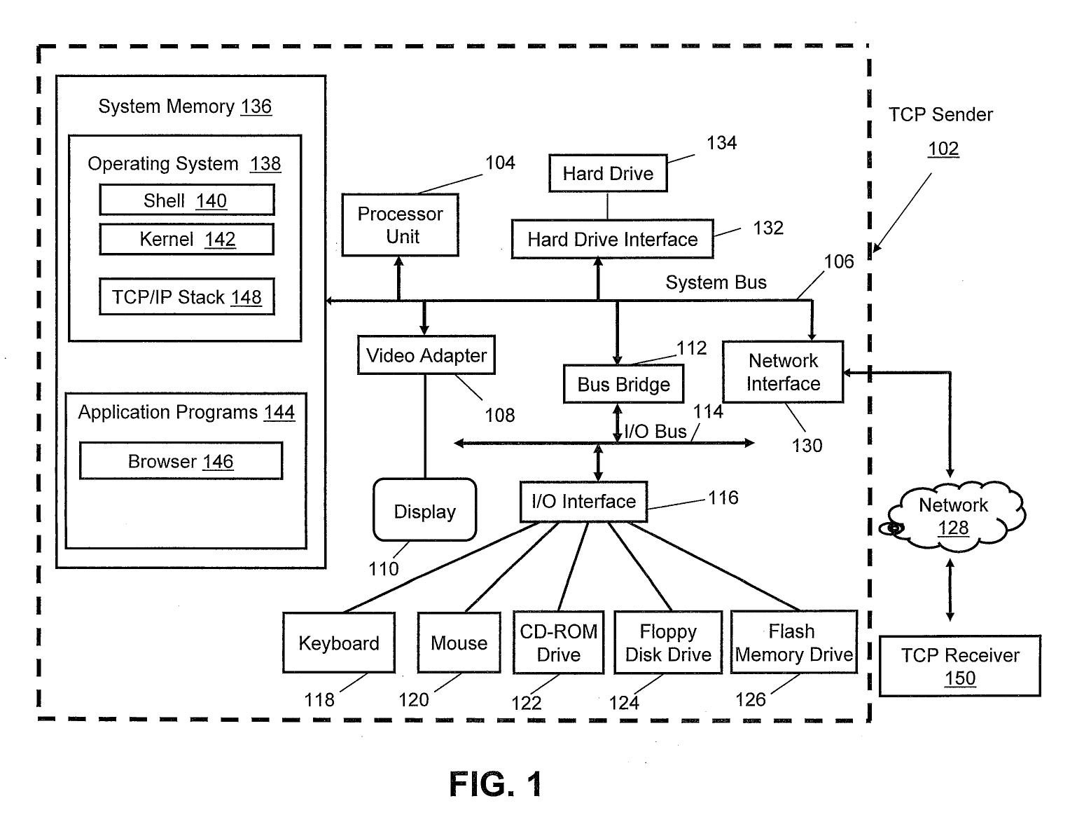

With reference now to FIG. 1, there is depicted a block diagram of an exemplary TCP sender 102, with which the present invention may be utilized. TCP sender 102 is illustrated as a data processing system, having many hardware and software components of a data processing system utilized to complete application processing and TCP/IP network communication. Thus, TCP sender 102 includes processor unit 104 that is coupled to system bus 106. Video adapter 108, which drives/supports display 110, is also coupled to system bus 106. System bus 106 is coupled via bus bridge 112 to Input/Output (I/O) bus 114. I/O interface 116 is coupled to I/O bus 114. I/O interface 116 affords communication with various I/O devices, including keyboard 118, mouse 120, Compact Disk—Read Only Memory (CD-ROM) drive 122, floppy disk drive 124, and flash drive memory 126. The format of the ports connected to I/O interface 116 may be any known to those skilled in the art of computer architecture, including but not limited to Universal Serial Bus (USB) ports.

According to the invention, TCP sender 102 operates as a sender and/or receiver for TCP/IP transmission in a computer network. Thus, TCP sender 102 comprises network interface 130 by which TCP sender 102 communicates with TCP receiver 150 via network 128. Network interface 130 is coupled to system bus 106. Network 128 may be an external network such as the Internet, or an internal network such as an Ethernet or a Virtual Private Network (VPN). Network 128 includes TCP sender 102 and TCP receiver 150, which may be computers or other data processing systems. For purposes of the invention, network is any network that supports TCP/IP transmission based on the modified TCP provided by the present invention.

Hard drive interface 132 is also coupled to system bus 106. Hard drive interface 132 interfaces with hard drive 134. In a preferred embodiment, hard drive 134 populates system memory 136, which is also coupled to system bus 106. Data that populates system memory 136 includes operating system (OS) 138 and application programs 144 of TCP sender 102. TCP sender 102 thus comprises one or more application programs 144 within system memory 136. As shown, application programs 144 include browser 146, which enables user access to the World Wide Web (WWW) to send and receive network messages to the Internet.

OS 138 includes shell 140 (as called in UNIX®), for providing transparent user access to resources such as application programs 144. Generally, shell 140 is a program that provides an interpreter and an interface between the user and the operating system. As depicted, OS 138 also includes kernel 142, which includes lower levels of functionality for OS 138, including providing essential services required by other parts of OS 138 and application programs 144, including memory management, process and task management, disk management, and mouse and keyboard management. Similarly, OS 138 includes TCP/IP stack 148, which includes functionality for TCP and IP data transmission. In an embodiment of the present invention, TCP/IP stack 148 is modified such that every data packet sent by TCP/IP stack 148 includes both data and INPCB address information. In such an embodiment, TCP/IP stack 148 may be modified in TCP sender 102 and/or TCP receiver 150. When TCP sender 102 comprises TCP/IP stack modified to provide this feature (INPCB address information within the data packet), the TCP/IP provides notice of this functionality during set up of a TCP/IP session with TCP receiver 150.

The hardware elements depicted in TCP sender 102 are not intended to be exhaustive, but rather are representative to highlight certain components that mat be utilized to practice the present invention. For instance, TCP sender 102 may include alternate memory storage devices such as magnetic cassettes, Digital Versatile Disks (DVDs), Bernoulli cartridges, and the like. These and other variations are intended to be within the spirit and scope of the present invention.

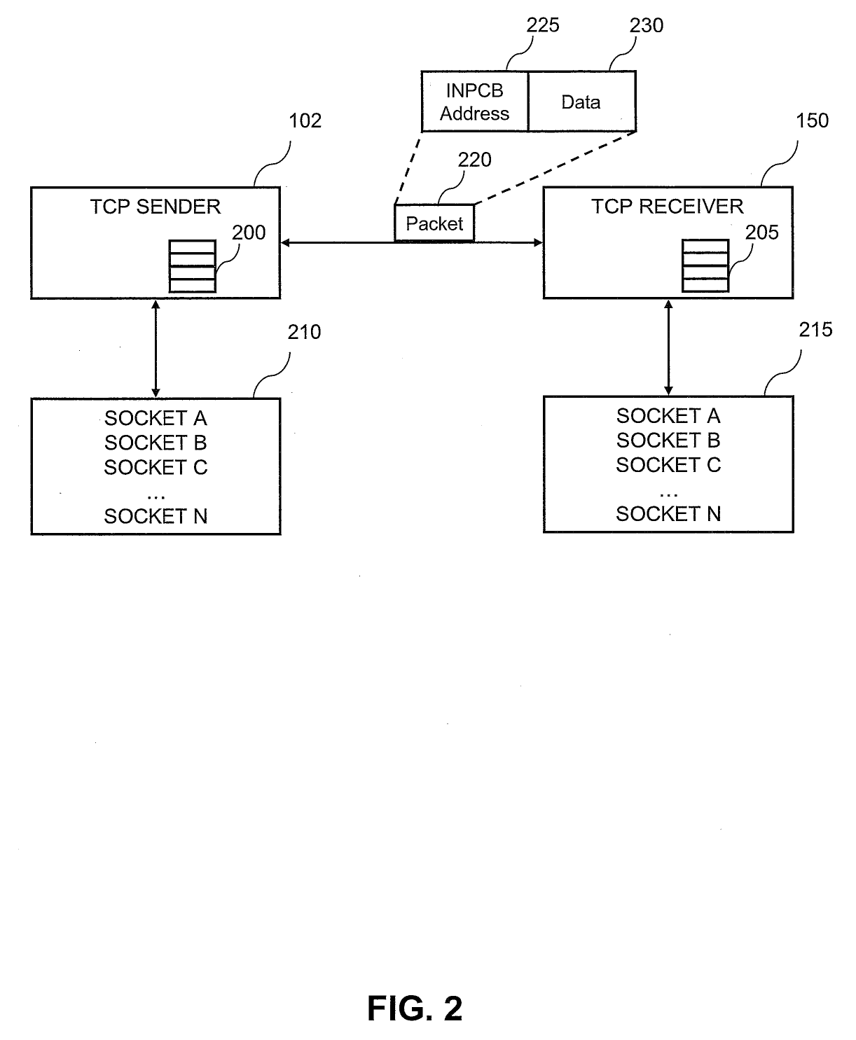

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

With reference now to FIG. 2, there is depicted a simplified block diagram of a TCP transmission environment comprising Transmission Control Protocol (TCP) sender 102 communicating with TCP receiver 150 via data packet transmission across a network connection. FIG. 2 also illustrates INPCB lookup table 200 associated with TCP sender 102, INPCB lookup table 205 associated with TCP receiver 150, a plurality of sockets 210 associated with TCP sender 102, and another plurality of sockets 215 associated with TCP receiver 150. Finally, data packet 220 is illustrated transmitting between TCP sender 102 and TCP receiver 150.

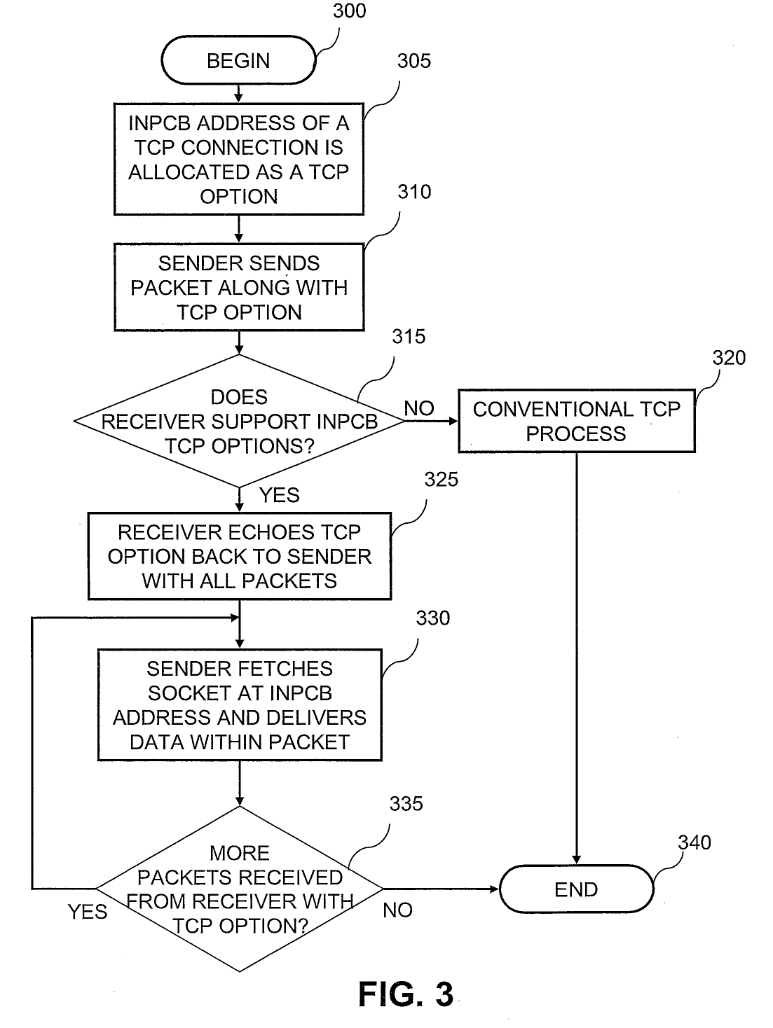

A TCP/IP connection is provided on which transmission of one or more data packet 220 is completed between TCP sender 102 and TCP receiver 150. TCP sender 102 is coupled to a plurality of sockets 210, which may contain data transmitted by (or received for) an application executing on TCP sender 102. Similarly, TCP receiver 150 is coupled to a plurality of sockets 215, which may also contain data (both sender and receiver data are represented by single TCP data 230). In an embodiment of the invention, data 230 contained within sockets 210 may be efficiently transmitted via network 128 to sockets 215 (and vice versa) through the use of a TCP connection implementing a modified TCP/IP stack 148 such that data packet 220 includes INPCB address 225 and data 230. An exemplary method of utilizing modified data packets with INPCB address information to substantially eliminate latency of INPCB address resolution of data packets transmitted over network 128 is provided in FIG. 3 and is discussed in detail below.

Although FIG. 2 depicts a TCP connection between a single TCP sender 102 and a single TCP receiver 150, in an alternate embodiment, a plurality of TCP connections could be formed between a one or more TCP senders 102 and a one or more TCP receivers 150. Similarly, although FIG. 2 depicts sockets 210 and 215 as comprising a plurality of sockets (A through N), the number of sockets is variable and N is provided solely for illustration.

Turning now to FIG. 3, there is depicted a high-level, logical flowchart of an exemplary method of utilizing a TCP connection to transmit data packet 220 over network 128 from the perspective of TCP sender 102, in accordance with one embodiment of the invention. The TCP data transmission process begins at block 300 when one of application programs 144 at TCP sender 102 begins a data transmission session. At block 305, TCP/IP stack 148 allocates INPCB address 225 corresponding to the location of data 230 within sockets 210 and generates data packet 220 comprising data 230 and INPCB address 225. In one embodiment of the invention, TCP/IP stack 148 within TCP sender 102 defines INPCB address 225 as a TCP option (e.g. TCP_INPCB_COOKIE). In this embodiment, INPCB address 225 does not change throughout the life of the TCP connection (session). At block 310, TCP sender 102 transmits data packet 220, which comprises data 230 along with corresponding INPCB address 225, to TCP receiver 150.

In an alternate embodiment of the present invention, TCP/IP stack 148 within TCP sender 102 may define the INPCB address as an Internet Protocol (IP) option. In such an embodiment, an IP option containing an INPCB address may be transmitted via any transport layer protocol, such as TCP, User Datagram Protocol (UDP), Stream Control Transmission Protocol (SCTP), Datagram Congestion Control Protocol (DCCP), Reliable User Datagram Protocol (RUDP), Real-time Transport Protocol (RTP), and the like. At block 315, a determination is made whether the TCP/IP stack within TCP receiver 150 generally supports data packets that include INPCB addresses as TCP options.

According to the illustrative embodiment, data packet generation with the TCP option is only provided when both the TCP sender and TCP receiver have their TCP/IP stacks modified to automatically generate enhanced TCP data packets 220. Thus, it is contemplated that only some network devices on network 128 have TCP/IP stacks modified/configured to support the TCP options, in accordance with the present invention. If the TCP/IP stack within TCP receiver 150 does not support modified TCP options that contain INPCB addresses, a standard (or conventional) TCP transmission process is utilized and TCP receiver 150 ignores the TCP option, if the TCP option is included within the data packet, as depicted in block 320. TCP receiver 150 performs a conventional INPCB lookup operation from INPCB lookup table 205 located within system memory. During this conventional INPCB lookup operation, the local port, foreign port, local address, and foreign address information contained in data 220 are compared with the local port, foreign port, local address, and foreign address information of each INPCB within INPCB lookup table 205 until the appropriate INPCB address 225 is found. TCP receiver 150 may then deliver data 230 to the corresponding location within sockets 215. In accordance with the conventional TCP transmission process, INPCB lookup tables 200 and 205 may be accessed multiple times for all data packets transmitted between TCP sender 102 and TCP receiver 150. When no additional data packets are being transmitted, the conventional TCP transmission process terminates at block 340 and the TCP connection is closed.

Returning to decision block 315, if TCP receiver 150 supports data packets that include INPCB addresses as TCP options, TCP receiver 150 thereafter echoes all data packets 220 (including acknowledgments of received data packets) transmitted back to TCP sender 102 with the INPCB address included, as shown in block 325. At block 330, TCP sender 102 receives the data packet(s) from TCP receiver 150 and immediately forwards data 230 to the correct socket 210 (or application) corresponding to INPCB address 225 within the received data packet 220. In this way TCP sender 102 automatically delivers received data 230 to the appropriate location within sockets 210, thereby bypassing INPCB lookup table 200 of TCP sender 102. A decision is made at block 335 whether additional data packets are received by TCP sender 102 from TCP receiver 150. If additional data packets are being received by TCP sender 102, TCP sender 102 fetches data 230 from the received data packets 220 and accesses the INPCB address 225 within data packet 220. TCP sender 102 then forwards data 230 for delivery to the appropriate socket 210 corresponding to the INPCB address at block 330, thereby bypassing INPCB lookup table 200. If no additional data packets are being received by TCP sender 102, the process terminates at block 340 and the TCP connection is closed.

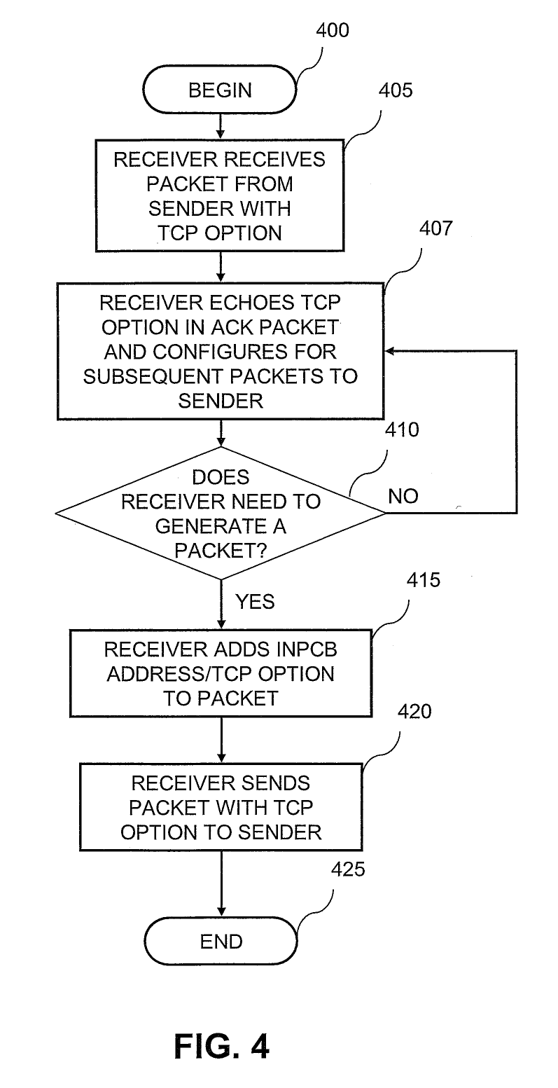

Turning now to FIG. 4, there is depicted a high level logical flowchart of an exemplary method of responding to a receipt by TCP receiver 150 of a data packet 220 modified with a TCP option of a TCP sender 102, in accordance with one embodiment of the invention. The TCP data transmission process begins at block 400 when one of application programs 144 begins a data transmission session with a modified TCP/IP stack, as provided in FIG. 3. TCP receiver 150 completes the TCP connection with TCP sender 102. At block 405, TCP receiver 150 receives data packet 220, comprising INPCB address 225 (as a TCP option) and data 230, from TCP sender 102. At block 407, TCP receiver 150 echoes the TCP option back to TCP sender 102 within an acknowledgement (ACK) packet. The TCP/IP stack within TCP receiver 150 then configures TCP receiver 150 to transmit subsequent data packets to TCP sender 102.

A determination is made at block 410 whether TCP receiver 150 is generating a data packet 220 for transmission back to TCP sender 102. If a packet is being generated, TCP/IP stack within TCP receiver 150 generates data packet 220 and includes INPCB address 225 as a TCP option along with data 230 within data packet 220, as shown at block 415 At block 420, TCP receiver 150 transmits data packet 220 to TCP sender 102, which is then able to process data packet 220 without requiring an INPCB table lookup. The process at TCP receiver 150 terminates at block 425 when the TCP connection is closed.

Assuming TCP receiver 150 is configured with a modified TCP/IP stack and that TCP receiver 150 is receiving packets for an application at TCP receiver that has established its INPCB address with TCP sender, TCP receiver 150 utilizes INPCB address 225 to deliver data 230 to the corresponding location within sockets 215. This portion of the process is similar to that of TCP sender 102 illustrated by FIG. 3. The remainder of the process, however, assumes that the TCP receiver is receiving packets of and/or generating packets for application 144 at TCP sender 102.

In accordance with the present invention, the utilization of modified TCP/IP stack 148 to generate TCP options within data packets, whereby INPCB address information is transmitted along with the data, substantially eliminates the utilization of INPCB lookup tables 200 and 205. These tables are otherwise repeatedly accessed during conventional TCP/IP transmission sessions. The present invention thus enables quick, efficient, and scalable TCP communication.

It is understood that the use herein of specific names are for example only and not meant to imply any limitations on the invention. The invention may thus be implemented with different nomenclature/terminology and associated functionality utilized to describe the above devices/utility, etc., without limitation.

Note that while an illustrative embodiment of the present invention has been, and will continue to be, described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. In a computer network environment having a Transmission Control Protocol (TCP) sender and a TCP receiver transmitting data packets via TCP/Internet Protocol (IP), a method comprising:
defining an Internet Protocol Control Block (INPCB) address as an IP option within a TCP/IP stack, wherein the INPCB address identifies a socket within the TCP sender corresponding to an application which generates the data;
generating a data packet comprising data;
encapsulating the INPCB address within the data packet;
transmitting the data packet, which includes the INPCB address, to the TCP receiver; and
when a receiver-generated data packet having the INPCB address encapsulated therein is received from the network environment, automatically forwarding data from the receiver-generated data packet to the socket identified by the INPCB address;
wherein latency of INPCB lookup operations at an INPCB lookup table of the TCP sender is substantially eliminated when a receiver-generated data packet having the INPCB is received is received.

2. The method of claim 1, wherein defining INPCB address as an IP option specifically defines the INPCB address as a TCP option, such as a TCP_INPCB_cookie.

3. The method of claim 1, wherein said defining an INPCB address as an IP option defines the INPCB address as an IP option that is transmitted via a transport layer protocol from among TCP, User Datagram Protocol (UDP), Stream Control Transmission Protocol (SCTP), Datagram Congestion Control Protocol (DCCP), Reliable User Datagram Protocol (RUDP), and Real-time Transport Protocol (RTP).

4. The method of claim 1, wherein said defining the INPCB address comprises defining the INPCB address during set up of the socket for the application desiring to establish a TCP session, such that the INPCB address does not change throughout the life of the TCP session established by the socket.

5. The method of claim 1, further comprising:
establishing a TCP session with the TCP receiver;
forwarding the initial data packet including the INPCB address to the TCP receiver;
monitoring for receipt of an acknowledgement (ACK) response packet from the TCP receiver that indicates whether the TCP receiver supports generation and transmission of data packets with the INPCB address encapsulated therein as a TCP option;
when the TCP/IP stack of the TCP receiver supports generation and transmission of data packets with the INPCB address included as a TCP option, automatically forwarding all data packets received from TCP receiver, which include the INCPB address of the socket, to the socket without performing an INPCB table lookup; and
when the TCP/IP stack of the TCP receiver does not support generation and transmission of data packets with the INPCB address included as a TCP option:
completing subsequent data packet transmission via the TCP session without the TCP option included within the data packet; and
performing a conventional INPCB lookup operation from an INPCB lookup table of the TCP sender for received data packets.

6. The method of claim 1, further comprising:
on receipt of data packet(s) including the INPCB address of the socket, parsing the received data packet for the INPCB address of the TCP sender; and
immediately forwarding data from within the data packets to the socket and application corresponding to the INPCB address, without accessing the INPCB lookup table of TCP sender.

7. The method of claim 6, further comprising:
when an initial request for activation of a second TCP session is received from a second TCP sender, parsing the request for a second TCP option including a second INPCB address associated with a socket of the second TCP sender, which generated the data packet;
automatically echoing the second INPCB address back to the second TCP sender within an acknowledgement (ACK) packet of the initial request; and
encapsulating the second INPCB within each subsequent data packet generated for transmission via the second TCP session;
wherein subsequent data packets transmitted from the TCP sender on the second TCP session includes at least the INPCB address of the TCP sender and the second INPCB address of the second TCP sender.

8. The method of claim 1, further comprising:
modifying a TCP/IP stack of the TCP sender to generate TCP options within each data packet, wherein said TCP options include INPCB address information transmitted along with data, such that utilization of INPCB lookup tables is substantially eliminated;
notifying a TCP receiver of the addition of the TCP option during establishment of the initial TCP session, wherein a response ACK is triggered from the TCP receiver indicating whether or not the TCP receiver supports transmission of TCP data packets with the INPCB address included therein;
during creation of any data packet for transmission to the TCP receiver, automatically encapsulating within the data packet an INPCB address of a receiving socket corresponding to the receiver application within the TCP receiver as a TCP option; and
transmitting the data packet to the TCP receiver including the INPCB address of.

9. A computer program product comprising a computer readable medium and program code on the computer readable medium that, when executed, completes the functions of claim 1.

10. A computer program product comprising a computer readable medium and program code on the computer readable medium that, when executed, completes the functions of claim 5.

11. A computer program product comprising a computer readable medium and program code on the computer readable medium that, when executed, completes the functions of claim 7.

12. A computer program product comprising a computer readable medium and program code on the computer readable medium that, when executed, completes the functions of claim 8.

13. A system comprising:
a Transmission Control Protocol (TCP) sender that includes:
means for defining an Internet Protocol Control Block (INPCB) address as an IP option within a TCP/IP stack, wherein the INPCB address identifies a socket within the TCP sender corresponding to an application which generates the data;
means for generating a data packet comprising data;
means for encapsulating the INPCB address within the data packet;
means for transmitting the data packet, which includes the INPCB address, to the TCP receiver; and
when a receiver-generated data packet having the INPCB address encapsulated therein is received from the network environment, means for automatically forwarding data from the receiver-generated data packet to the socket identified by the INPCB address;
wherein latency of INPCB lookup operations at an INPCB lookup table of the TCP sender is substantially eliminated when a receiver-generated data packet having the INPCB is received is received.

14. The system of claim 13, further comprising:
a computer network;
a TCP receiver coupled to the TCP sender via a TCP session established over the computer network; and
an INPCB lookup table associated with the TCP sender and a second INPCB lookup table associated with the TCP receiver;
a plurality of sockets associated with the TCP sender, said sockets containing data transmitted by and received for an application executing on TCP sender;
initiating a TCP data transmission session via an application at the TCP sender;
allocating via the TCP/IP stack an INPCB address corresponding to the location of data within sockets; and
means for transmitting data packets via TCP/Internet Protocol (IP), wherein said data packets include the INPCB address of the TCP sender.

15. The system of claim 13, wherein said means for defining INPCB address as an IP option includes means for specifically defining the INPCB address as a TCP option, such as a TCP_INPCB_cookie.

16. The system of claim 13, wherein said means for defining an INPCB address as an IP option includes:
means for defining the INPCB address during set up of the socket for the application desiring to establish a TCP session, such that the INPCB address does not change throughout the life of the TCP session established by the socket; and
means for defining the INPCB address as an IP option that is transmitted via a transport layer protocol from among TCP, User Datagram Protocol (UDP), Stream Control Transmission Protocol (SCTP), Datagram Congestion Control Protocol (DCCP), Reliable User Datagram Protocol (RUDP), and Real-time Transport Protocol (RTP).

17. The system of claim 14, further comprising:
means for establishing a TCP session with the TCP receiver;
means for forwarding the initial data packet including the INPCB address to the TCP receiver;
means for monitoring for receipt of an acknowledgement (ACK) response packet from the TCP receiver that indicates whether the TCP receiver supports generation and transmission of data packets with the INPCB address encapsulated therein as a TCP option;
when the TCP/IP stack of the TCP receiver supports generation and transmission of data packets with the INPCB address included as a TCP option, means for automatically forwarding all data packets received from TCP receiver, which include the INCPB address of the socket, to the socket without performing an INPCB table lookup; and
when the TCP/IP stack of the TCP receiver does not support generation and transmission of data packets with the INPCB address included as a TCP option:
means for completing subsequent data packet transmission via the TCP session without the TCP option included within the data packet; and
means for performing a conventional INPCB lookup operation from an INPCB lookup table of the TCP sender for received data packets.

18. The system of claim 14, further comprising:
on receipt of data packet(s) including the INPCB address of the socket, means for parsing the received data packet for the INPCB address of the TCP sender; and
means for immediately forwarding data from within the data packets to the socket and application corresponding to the INPCB address, without accessing the INPCB lookup table of TCP sender.

19. The system of claim 14, further comprising:
means, when an initial request for activation of a second TCP session is received from a second TCP sender, for parsing the request for a second TCP option including a second INPCB address associated with a socket of the second TCP sender, which generated the data packet;
means for automatically echoing the second INPCB address back to the second TCP sender within an acknowledgement (ACK) packet of the initial request; and
means for encapsulating the second INPCB within each subsequent data packet generated for transmission via the second TCP session;
wherein subsequent data packets transmitted from the TCP sender on the second TCP session includes at least the INPCB address of the TCP sender and the second INPCB address of the second TCP sender.

20. The system of claim 13, further comprising:
means for modifying a TCP/IP stack of the TCP sender to generate TCP options within each data packet, wherein said TCP options include INPCB address information transmitted along with data, such that utilization of INPCB lookup tables is substantially eliminated;
means for notifying a TCP receiver of the addition of the TCP option during establishment of the initial TCP session, wherein a response ACK is triggered from the TCP receiver indicating whether or not the TCP receiver supports transmission of TCP data packets with the INPCB address included therein;
means for during creation of any data packet for transmission to the TCP receiver, automatically encapsulating within the data packet an INPCB address of a receiving socket corresponding to the receiver application within the TCP receiver as a TCP option; and
means for transmitting the data packet to the TCP receiver including the INPCB address.
